(19) United States
(12) Patent Application Publication
(10) Pub. No.: US 2011/0205046 A1
(43) Pub. Date: Aug. 25, 2011

(54) TIRE DETECTION APPARATUS

(76) Inventor: PEI-CHENG CHIU, Tzuo Ying Dist. (TW)

(21) Appl. No.: 12/712,196

(22) Filed: Feb. 25, 2010

(51) Int. Cl. B60C 23/02; G10L 21/00

(52) U.S. Cl. 340/442; 704/274; 704/E21.001

(57) ABSTRACT

A tire detection apparatus detects the conditions of a tire of a vehicle and a host device controls a voice broadcasting device to make voice broadcasting of the result of detection. An operation device is also provided to allow for a driver of the vehicle to operate the apparatus. With the driver's operation of the operation device, the voice broadcasting device of the host device can timely broadcast the result of tire detection to the driver. A forced broadcasting mechanism is also provided, which helps eliminating the situation where a fault normal condition of the tire is incorrectly recognized by the driver due to unawareness of abnormality of the apparatus and thus improving driving safety.

### (a) TECHNICAL FIELD OF THE INVENTION

The present invention generally relates to a tire detection apparatus, and more particularly to an apparatus that detects the condition of a tire and thus makes a voice broadcasting of the result of tire detection and also allows for forced broadcasting that generates voice message at any desired time.

### (b) DESCRIPTION OF THE PRIOR ART

Tires are important parts of a vehicle. Besides tracks and caterpillar bands, tires are the heavily depended by the most on-ground vehicles for movement. Tires are made of rubber materials. Due to the difference in the manufacturing processes adopted by different manufacturers, different rubber additives, and different tread patterns, tires from different manufacturers and of different modes have significant difference in respect of durability, water expulsion, road gripping, and noise.

Tire pressure and temperature are also important issues for tires when the tires are running on a road. This is important to maintain service life of the tires and eliminate potential risks of tire explosion and thus ensure driving safety. Probably due to bad driving habit or simply due to abnormality of detection instruments, drivers are often reluctant to detect the tire pressure and temperature. This is often a more severe problem when a vehicle is put in operation for the tire pressure and temperature will increase with the movement of the vehicle. This issue gets noticed recently and some techniques are currently available for detection and alarming improper tire pressure and temperature, such as Taiwan Patent Nos. I295975, I233402, and I296241 and Taiwan Utility Model No. M318528. However, those known techniques can still be further improved and the present invention is made to provide a tire detection apparatus for such a purpose.

### SUMMARY OF THE INVENTION

The present invention provides a tire detection apparatus that detects the conditions of a tire of a vehicle and broadcasts the result of detection with voice. Further, the tire detection apparatus of the present invention provides a forced broadcasting mechanism, which allows a driver of the vehicle to force the apparatus to provide tire condition broadcasting at any desired time, whereby fault result of detection that leads to misrecognition of normal condition of the tire caused by malfunctioning of the apparatus can be eliminated to ensure driving safety.

For such a purpose, the present invention provides a tire detection apparatus that comprises a host device, a plurality of tire detection modules and an operation device. The host device comprises a CUP based control system, a wireless signal receiving device, and a voice broadcasting device. The tire detection modules are respectively mounted to tires of a vehicle. Each tire detection module functions to detect the detectable parameters of the respective tire and transmits the result of detection with wireless signals to the host device. The host device, after processing the result of detection and determining an abnormal condition occurs, drives the voice broadcasting device to broadcast the abnormal condition with voice. The operation device is operable by a user to cause the host device to supply an out signal that forces the voice broadcasting device to carry out immediate broadcasting.

Another objective of the present invention is to provide a tire detection apparatus that comprises an operation device that is set in connection with a host device in a wireless remote-control manner. By separating the operation device from the host device, the installation of the host device is not subjected to any location constrain. Further, a driver, when leaving the vehicle, is also allowed to carry out remote control of the tire detection apparatus with the operation device.

A further objective of the present invention is to provide a tire detection apparatus that comprises an operation device set in wired connection with a host device, so that the installation of the host device can be done at a site where operation of the apparatus by a user or vehicle driver can be conveniently carried out to facilitate the convenience of the apparatus by the driver.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a tire detection apparatus according to an embodiment of the present invention.

FIG. 2 is a block diagram illustrating the setting operation of the tire detection apparatus for tires of a vehicle.

FIG. 3 is a block diagram of a tire detection apparatus according to another embodiment of the present invention.

FIG. 4 is a block diagram of a tire detection apparatus according to a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

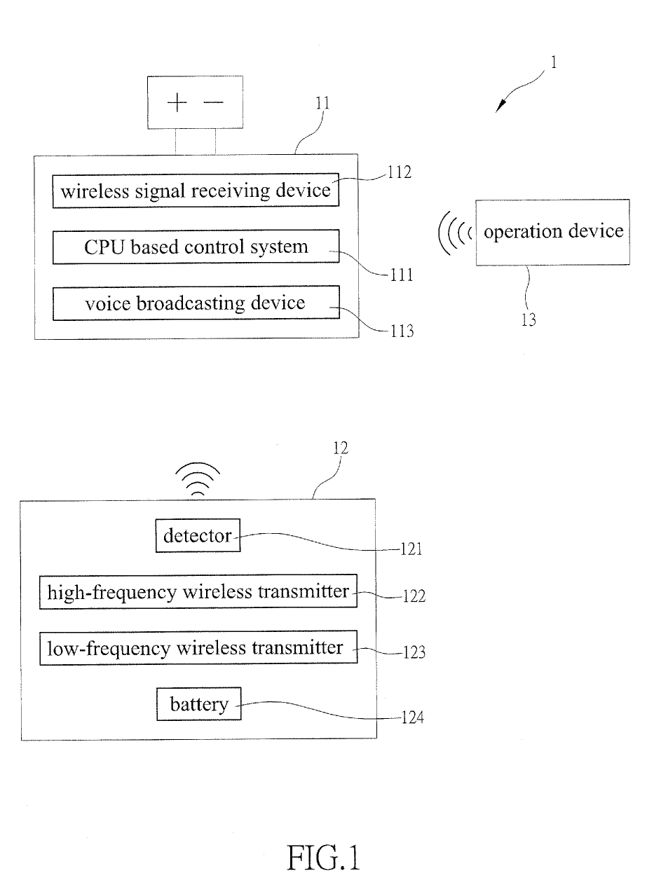

Referring to FIG. 1, the present invention provides a tire detection apparatus, generally designated at 1, which comprises at least a host device 11, a plurality of tire detection modules 12, and an operation device 13.

The host device 11 comprises a CPU based control system 111, a wireless signal receiving device 112, and a voice broadcasting device 113.

The tire detection modules 12 are respectively mounted in tires of a vehicle.

The operation device 13 is operable to provide signal outputs, with which the CPU based control system 111 controls the voice broadcasting device 113 to perform a broadcasting operation.

To practice, the CPU based control system 111 of the host device 11 are connected to the wireless signal receiving device 112 and the voice broadcasting device 113. The CPU based control system 111 is pre-loaded with reference values of detectable parameters of tires, such as reference tire pressure, reference temperature, and reference voltage. The wireless signal receiving device 112 of the host device 11 functions to receive wireless signals transmitted from the tire detection modules 12 of the tires and a wireless signal from the operation device 13.

Each of the tire detection modules 12 comprises a detector 121, a high-frequency wireless transmitter 122, a low-frequency wireless receiver 123, and a battery 124. Each tire detection module 12 uses the detector 121 to timely detect the conditions of the respective tire, such as tire pressure, temperature, and voltage level of the battery 124 and transmits the detected data in wireless signals through the high-frequency wireless transmitter 122 to the host device 11. The host device 11 receives the wireless signals through the wireless signal receiving device 112 and conveys the received wireless signals to the CPU based control system 111 for comparison. If the result of comparison indicates that the tire conditions do not exceed the preset reference values, the CPU based control system 111 takes no action; on the other hand, if the comparison indicates that any item of the tire conditions exceeds the respective reference value, the CPU based control system 111 generates and supplies an output signal to instruct the voice broadcasting device 113 to perform voice broadcasting, by which a driver of the vehicle may be notified of the tire conditions.

The high-frequency wireless transmitter 122 of the tire detection module 12 can be operated in such a mode of transmission that the transmission is done in an intermittent manner at a preset time interval in order to reduce power consumption of the battery 124. The voice broadcasting device 113 of the host device 11 can be structured to provide a fixed broadcasting mode to remind a driver of a condition that one of the tire parameters exceeds the reference value, or alternatively, a variable broadcasting mode can be arranged to change the contents of broadcasting according to the result of detection mentioned above in order to more precisely handle the practical situations of the tires and enhance alarming effect.

Alternatively, the CPU based control system 111 can be arranged in such a way that after the first time or first several times of broadcasting of a situation made by the voice broadcasting device 113, the broadcasting is then temporarily suspended and switched to the intermittent broadcasting mode that makes broadcasting only at a preset time interval in order to avoid interference with the driver with successive and repeated voice broadcasting. Or, the operation device 13 may be operated to issue a signal that is used to instruct the CPU based control system 111 to provide a signal output for temporarily suspending the broadcasting operation of the voice broadcasting device 113, resulting in silencing, and again helping reducing interference with the driver by “over-broadcasting”.

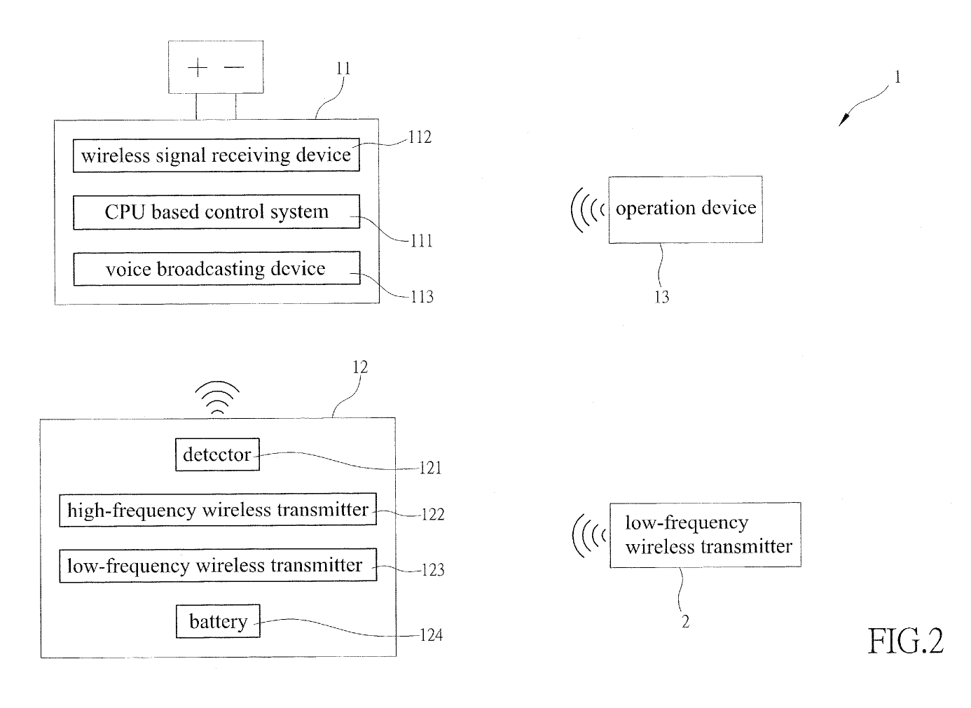

As shown in FIG. 2, the corresponding tire that is indicated by a tire detection module 12 mounted thereto can be set through the host device 11, the tire detection module 12, and the operation device 13 and also through a low-frequency wireless transmitting device 2. The operation of setting is started by activating the electrical power system of the vehicle to which the tire is mounted and also turning on the operation device 13, and at this point, the host device 11 enters a setting mode. The voice broadcasting device 113 of the host device 11 notifies the beginning of the setting mode with voice broadcasting. The broadcasting provided by the voice broadcasting device 113 also help identifying the sequence of operation of setting. An operator or user holds and brings the low-frequency wireless transmitting device 2 close to the tire and activates the low-frequency wireless transmitting device 2 to issue a low frequency wireless signal, which will be received by the low-frequency wireless receiver 123 of the tire detection modules 12 mounted in the tire, whereby the high-frequency wireless transmitter 122 of the tire detection modules 12 automatically issues a high frequency wireless signal. The high frequency wireless signal is received by the wireless signal receiving device 112 of the host device 11 and transmitted to the CPU based control system 111 of the host device 11. The setting operation can thus be completed through electronic logic circuit included in the CPU based control system 111. After the completion of the setting operation for each tire according to present invention, the voice broadcasting device 113 of the host device 11 makes broadcasting to indicate the completion of the operation to help the user to confirm the completion of the operation. Broadcasting may also be made in respect of the next tire to be set, so that the user may carry out the setting operation in correct sequence. Once all the tires of the vehicle are properly set, the voice broadcasting device 113 makes an ending broadcasting to indicate the completion of setting of all tires.

To allow a driver of a vehicle to timely aware of the normal operation of the present invention, a real-time forced broadcasting operation can be carried out by the voice broadcasting device 113 as being controlled by using the operation device 13 of the present invention. Namely, the operation device 13 is manually operated to issue a wireless signal, which is received by the wireless signal receiving device 112 of the host device 11 and applied to the CPU based control system 111. After receiving the signal, the CPU based control system 111 immediately supplies an output signal to instruct the voice broadcasting device 113 to carry out an instantaneous broadcasting. Since at that moment, the tire detection module 12 is in transmission of tire condition data through the detector 121 thereof, the voice broadcasting device 113 will broadcast the tire conditions detected and transmitted at that moment. In other words, even the conditions of tire that are detected by the tire detection module 12 at that moment are not abnormal, the voice broadcasting device 113 is still activated to broadcast the tire conditions. After the real-time tire condition broadcasting made by the voice broadcasting device 113 is completed, the CPU based control system 111, which is of a proper design, may issue a signal to stop the broadcasting operation of the voice broadcasting device 113 and make the voice broadcasting device 113 resuming a mode where only abnormal conditions of the tire will be broadcast. The driver may get aware of the tire conditions in a real time manner through the forced broadcasting mechanism and through such a mechanism, the driver may realize if the tire detection apparatus 1 of the present invention is in a normal condition for detection operation.

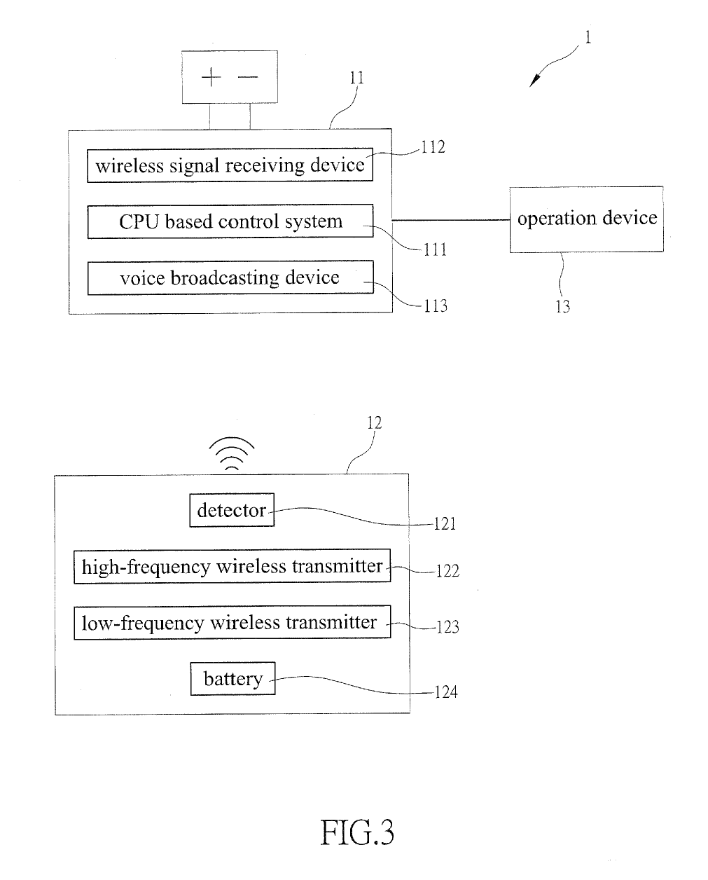

As shown in FIG. 3, another embodiment of the present invention is provided, in which modification is made to the connection between the operation device 13 and the host device 11 to accommodate variations in different applications. The operation device 13 is set in wired connection to the host device 11, or alternatively, the operation device 13 is combined with the host device 11 as a unitary device. For both cases, namely the operation device 13 being in wired connection with the host device 11 or being combined together as a unitary device, through proper design of electronic circuit, the CPU based control system 111 of the host device 11 is still under control by the operation device 13, whereby for real time and forced broadcasting, the driver may operate the operation device 13 to cause the CPU based control system 111 to instruct the voice broadcasting device 113 to carry out forced broadcasting.

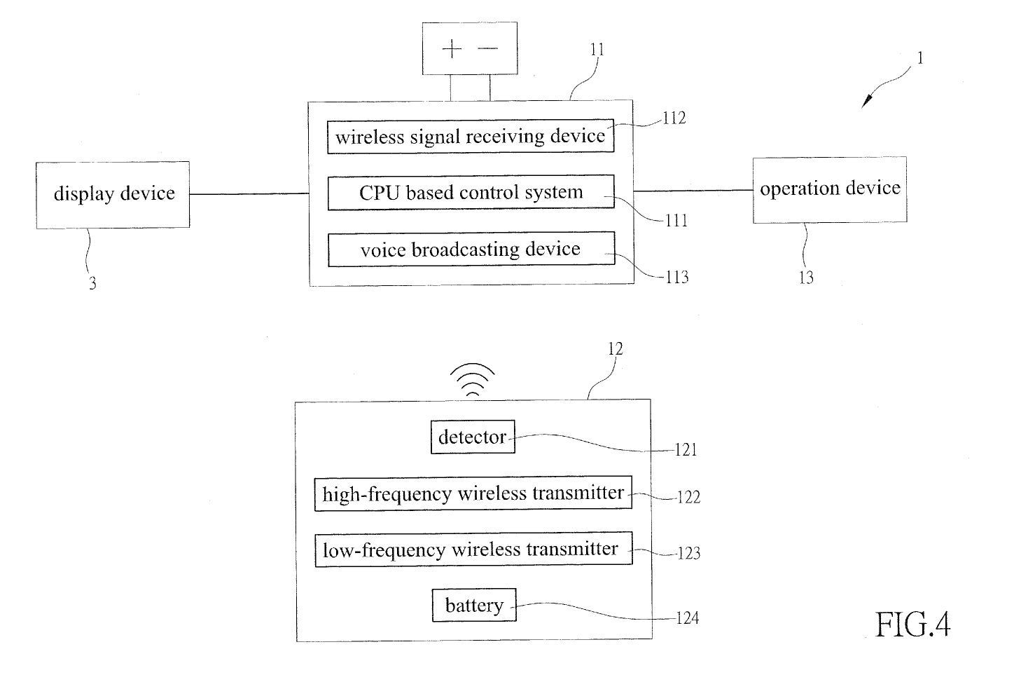

As shown in FIG. 4, in a further modification according to the present invention, the host device 11 is connected to a display device 3. Through proper design of electronic circuit, when the voice broadcasting device 113 of the host device 11 is making a broadcasting of tire conditions, the display device 3 may show the contents of the broadcasting at the same time. Thus, besides audio alarm, the present invention may also provide visual alarm.

With the forced broadcasting mechanism according to the present invention, a driver of a vehicle may timely realize if the tire detection apparatus of the present invention is in normal operation. For a vehicle that has been not put into operation for quite a long time, before it to be driven again, a simple operation of the operation device 13 can tell the current conditions of the tires of the vehicle and also identify if the tire detection apparatus is in normal operation. This helps ensuring driving safety for the driver of the vehicle.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tire detection apparatus, comprising:
a host device, which comprises at least a CPU based control system, a wireless signal receiving device, and a voice broadcasting device, the CPU based control system being pre-loaded with reference values of detectable tire parameters, including at least tire pressure, temperature, and voltage;
a tire detection module, which is adapted to mounted to a tire of a vehicle to detect the tire parameters of the tire and transmits the detected tire parameters to the host device; and
an operation device, which is adapted to be operated by a user to supply an output signal that drives the host device to activate and de-activate the voice broadcasting device and stop broadcasting operation of the voice broadcasting device to form a silenced condition.

2. The tire detection apparatus according to claim 1, wherein the operation device controls the host device in a wireless remote-control manner.

3. The tire detection apparatus according to claim 1, wherein the operation device is in wired connection with the host device.

4. The tire detection apparatus according to claim 1, wherein the operation device is combined with the host device as a unitary device.

5. The tire detection apparatus according to claim 1, wherein the host device is connected to a display device, whereby when the voice broadcasting device of the host device is making a broadcasting operation of given contents, the display device shows the contents at the same time.

6. The tire detection apparatus according to claim 1, wherein the voice broadcasting device of the host device is arranged to stop the broadcasting operation of given contents after a first time or first several times of broadcasting of the given contents and then carry out the broadcasting the given contents in an intermittent fashion at a given time interval.

7. The tire detection apparatus according to claim 1, wherein to set the apparatus for a give tire of the vehicle, a low-frequency wireless transmitting device is brought close to the tire and activated to issue a low frequency wireless signal that is received by a low-frequency wireless receiver of the tire detection module mounted in the tire and, in response thereto, a high-frequency wireless transmitter of the tire detection module of the tire transmits a high frequency wireless signal, the high frequency wireless signal being received by the wireless signal receiving device of the host device and transmitted to the CPU based control system of the host device, whereby through an electronic logic circuit included in the CPU based control system, the setting operation of the apparatus for the given tire is completed.

8. The tire detection apparatus according to claim 7, wherein in setting the apparatus for the given tire, the voice broadcasting device of the host device makes a broadcasting indicating the beginning of the setting operation, guiding the sequence of the setting operation, and completion of the setting operation.
